(19) United States
(12) Patent Application Publication
(10) Pub. No.: US 2005/0289396 A1
(43) Pub. Date: Dec. 29, 2005

(54) Conditional breakpoint using breakpoint function and breakpoint command

(76) Inventors: Donald F. Hooper, Shrewsbury, MA (US); Eric Walker, Lancaster, MA (US); Dennis Rivard, Atkinson, NH (US); William R. Wheeler, Southborough, MA (US); Mark B. Rosenbluth, Uxbridge, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/877,457

(22) Filed: Jun. 25, 2004

(51) Int. Cl. G06F 11/00

(52) U.S. Cl. 714/34

(57) ABSTRACT

A conditional breakpointing mechanism associates a breakpoint with a location in a program and with a breakpoint function that will be called to execute when the location is reached during a debugging session. The breakpoint function determines if a break will occur. The conditional breakpointing mechanism may used in a multi-threaded, multi-processor simulation environment.

### BACKGROUND

Modem software debugging tools offer a wide range of features, but most have some sort of breakpointing mechanism to control program execution during a debug session. A breakpoint is used to halt program execution when a certain point in the program is reached. For example, a user can set a breakpoint at a specific line of code at which program execution is to be halted. Some software debugging tools even allow a user to set a breakpoint with a condition. Such a breakpoint is called a conditional breakpoint. Conditional breakpoints only stop or pause program execution if a specified condition is true. The condition is an expression that is evaluated when the breakpoint is encountered during program execution. The expression accesses program variables. If, while the program is executing, the expression evaluates to true, the program pauses, thus allowing the user to inspect the program variables.

### DESCRIPTION OF DRAWINGS

FIG. 1 shows a block diagram of an exemplary debugger that employs a simulator to simulate a processor and is usable to debug microcode developed for execution by the processor.

FIG. 2 shows a flow diagram depicting operation, in one exemplary embodiment, of a debugger conditional breakpointing mechanism that uses a breakpoint function and a breakpoint command.

FIG. 3 shows a block diagram of an exemplary processor (that is simulated by the simulator shown in FIG. 1) having multiple multi-threaded microengines.

FIG. 4 shows a block diagram of an exemplary microengine.

FIG. 5A shows an exemplary format of a breakpoint command.

FIG. 5B shows an exemplary format of a calling standard for a breakpoint function.

FIG. 6 shows a screen capture of an exemplary graphical user interface (GUI) thread window, with a pop-up menu usable to set unconditional breakpoints and to open a breakpoint properties dialog box.

FIG. 7 shows a screen capture of an exemplary GUI breakpoint properties dialog box through which a user can set a conditional breakpoint.

FIG. 8 shows a block diagram of a sample computer system suitable to be programmed with embodiments of a debugger with conditional breakpointing.

Like reference numerals will be used to represent like elements.

### DETAILED DESCRIPTION

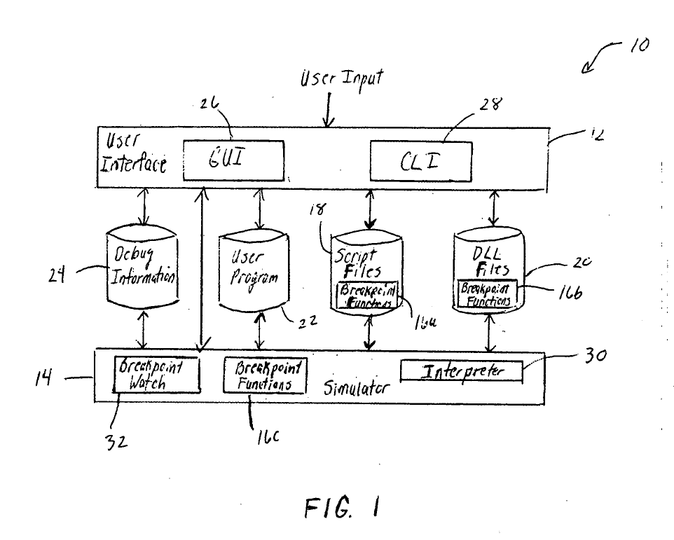

FIG. 1 shows a high-level view of a debugger 10 that features a conditional breakpointing mechanism. The debugger 10 is configured to debug a software program developed for use by a target processor. The debugger 10 is provided with various application software and other components, including a user interface 12 and a simulator 14 to simulate the target processor. When the debugger 10 is operating in a simulation mode of operation, the simulator 14 demonstrates the functional behavior and performance characteristics of a design based on the target processor without relying on the hardware. Both simulator 14 and user interface 12 include support for the conditional breakpointing mechanism, as will be described.

Still referring to FIG. 1, the debugger 10 also stores other software, including breakpoint functions 16, which in the embodiment shown can be provided in script files 18 (breakpoint functions 16a), DLL files 20 (breakpoint functions 16b) or both. As will be discussed later, breakpoint functions can also be defined by the user directly through the user interface 12 and stored locally in the simulator (shown as breakpoint functions 16c). The breakpoint functions 16 are defined or specified by the debugger user for simulation/debug purposes, that is, they are not part of or called by the user program to be debugged. The debugger 10 may also store files containing the program to be debugged (shown as “user program”) 22. In addition, the debugger 10 maintains debug information 24, some of which is produced by code development tools at build time. Other debug information includes state information describing the internal states that define the overall state of the processor model. The state information is generated over time during simulation (e.g., historical-information such as register or program counter values at different cycle times).

In the illustrated embodiment, the user interface 12 includes a graphical user interface (GUI) 26 as well as a command line interface (CLI) 28. A user can use one or both of these interfaces to interact with the simulator 14 in setting a conditional breakpoint on an instruction of the user program.

The conditional breakpoint mechanism allows a user to set a conditional breakpoint at a desired location in the user program, for example, on a particular instruction (“breakpoint instruction”). The conditional breakpoint has an associated function that is executed when the breakpoint instruction is reached during simulation. The breakpoint function results determine whether the program execution during simulation will be paused or will continue uninterrupted.

The breakpoint functions 16 may be implemented in any form that is understood by the simulator 14, e.g., in an interpreted (or scripting) language such as interpreted C, or a high-level system programming language such as C++. The breakpoint function can be made available to the simulator 14 in different ways, for example, it may be provided in a script created using the GUI 26 or CLI 28, or as a compiled software routine in a dynamic linked library (DLL). Scripts may be stored in script files (as script files 18) and executed by the user during simulation or as part of the simulation startup routine to load the functions into the simulator. Typically, script files are used to configure and control the simulation, as well as to access and manipulate simulation states. They may include a mixture of built-in simulator commands and interpreted source code (such as interpreted C). In addition, or alternatively, the breakpoint function may be defined interactively at the CLI command line or under GUI controls using a breakpoint editor, and then stored locally at the simulator (as shown in FIG. 1 with reference numeral 16c).

Foreign models can be used to integrate models of external hardware that may be connected to the target processor. Thus, the foreign model provides a mechanism by which the processor software model (of the simulator 14) can be extended to include additional software models of hardware that interfaces with the processor. One way to integrate a foreign model with the simulator is by creating a foreign model DLL. In the described embodiment, breakpoint functions may be defined in the foreign model DLL. The ability to define a breakpoint function in a foreign model DLL is particularly useful for more complex breakpoint functions, as the compiled code of the foreign model executes much faster than does its scripted language equivalent.

The foreign model DLL is activated by executing a ‘foreign_model’ command at the CLI command prompt or using appropriate simulation menu options of the GUI to cause the simulator to execute the command. When the simulator executes the foreign model command, it loads and initializes the foreign model DLL as well as obtains pointers to the foreign model functions to bind the foreign model DLL to the simulator. The foreign model maybe written in a high-level language like C++ that has access to chip simulator states, can receive callbacks from the simulator upon certain events (e.g., reset or simulation time change), and can register a breakpoint function for use by the command line or script. Thus, the breakpoint function 16 is a function available for calling on the simulator command line and by the interpreted source code of a script. The breakpoint function can be defined directly in a script file or can be defined in a foreign model and registered for use by the command line or script.

In the illustrated embodiment, the simulator 14 contains a built-in interpreter 30 to execute native simulator commands and other commands written in an interpreted (or scripting) language, such as interpreted C and Tcl. The interpreter 30 thus provides the simulator 14 with scripting capability so that script files can be used to run a sequence of native simulator and interpreted commands (e.g., C interpreted commands). The simulator 14 also maintains in a local table 32 breakpoint state (“breakpoint watch”) for each breakpoint that is established.

Although not depicted in FIG. 1, it will be appreciated that the debugger 10 may be part of a development environment. That development environment may include one or more code development tools, such as compiler, assembler, linker, and the like.

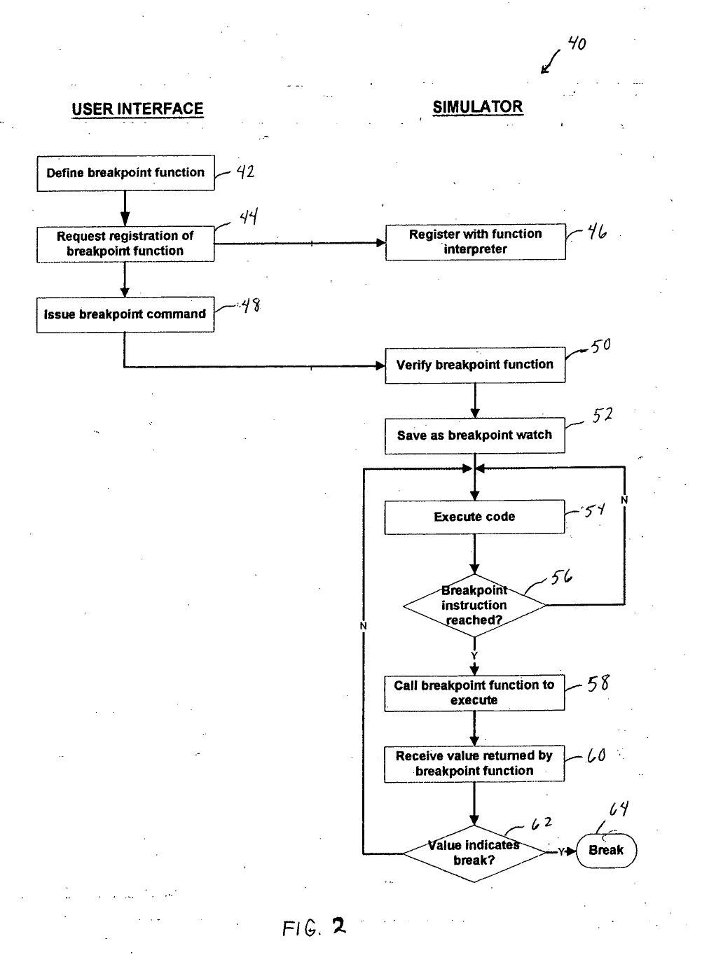

Referring now to FIG. 2 in conjunction with FIG. 1, an overview of an exemplary conditional breakpointing process 40 is shown. It will be appreciated from the figure that one portion of the process is performed by the software of the user interface 12 (operating in response to user input) and another portion is performed by the simulator 14 based on commands and other information received from the user via the user interface 12. The user interface 12 enables the user to define a breakpoint function (block 42) and to request registration of that breakpoint function (block 44). The breakpoint function definition includes a function declaration in which the body of the function is presented. The registration request may be a command that causes the simulator to load a breakpoint function defined in a DLL or execute a script or script file that declares a breakpoint function. In response to the registration request, the simulator 14 registers the breakpoint function with the interpreter 30 (block 46) as a function that can be executed from the simulator command line. The user interface 12 sends a breakpoint command, which specifies the breakpoint function by name and a location in the user program where a breakpoint is to be set, to the simulator (block 48). In response to the breakpoint command, the simulator 14 verifies the breakpoint function (e.g., that it has been registered, and conforms to the appropriate function calling standard) (block 50), and saves the information about the breakpoint as a breakpoint watch in the table 32 (block 52). As noted earlier, a breakpoint watch contains the state of the breakpoint and is used by the simulator 14 to detect that a breakpoint is reached during a simulation.

At some point after the breakpoint has been set on an instruction in the user program, the simulator 14 will start or resume code execution during a simulation session (block 54). As the code of the user program executes, line by line, the simulator 14 compares values corresponding to the executing instructions (e.g., program counter values, code line numbers, addresses or any other values that may be used to identify the instructions) to the breakpoint watch information to determine if the breakpoint instruction has been reached (block 56). If it is determined (at block 56) that the breakpoint instruction has been reached, the simulator 14 calls the breakpoint function associated with the breakpoint to execute (block 58). When a value is returned by the breakpoint function (block 60), the simulator 14 determines if that value indicates that a break should occur (block 62). If the returned value is true (“1”), the simulator 14 causes a break in the program execution (block 64). If the returned value is false (“0”), the simulator 14 allows the program execution to continue (returns to block 54) without pausing or stopping.

The operational flow of FIG. 2 is a high-level overview and depicts the simple case of only one breakpoint being set in a user program. It will be appreciated that the user may desire to set multiple breakpoints at different instructions via multiple breakpoint commands. The breakpoints may include conditional as well as unconditional breakpoints. The conditional breakpoints may use the same breakpoint function or different breakpoint functions (as determined by the breakpoint functions specified by the breakpoint commands that established those breakpoints). The simulator14 will use the breakpoint watches for the breakpoints to detect a breakpoint and to select the appropriate breakpoint function to be called for that breakpoint if the breakpoint is a conditional breakpoint. In addition, it will be understood that breakpoint definition (of block 42) and/or registration (blocks 44, 46) need only occur once for a given breakpoint function. That is, a user may cause a breakpoint command to be issued for a breakpoint function that is pre-existing, that is, one that is already defined and registered with the simulator software.

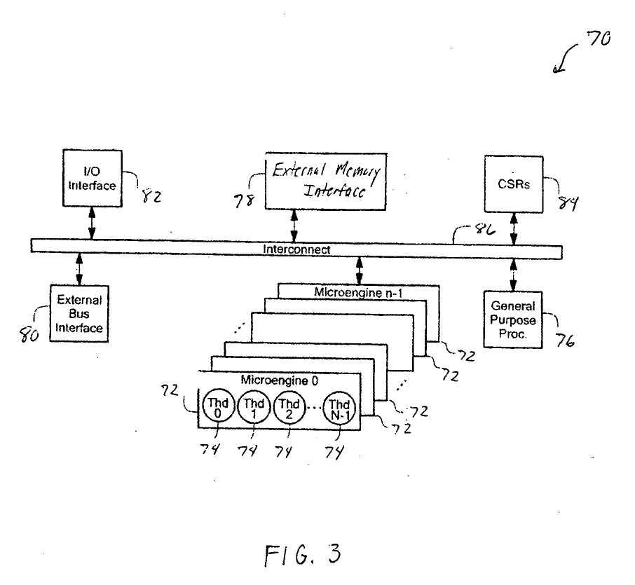

In one embodiment, the conditional breakpointing mechanism may be used in a multi-processor and multi-thread simulation. For example, and referring to FIG. 3, the target processor that is simulated by the simulator 14 (of FIG. 1) may be a processor 70 that includes one or more multi-threaded processing elements 72 to execute microcode. In the illustrated processor architecture, these processing elements 72 are depicted as “microengines” (or MEs), each with multiple hardware controlled execution threads 74. Each of the microengines 72 is connected to and can communicate with adjacent microengines. In the illustrated embodiment, the processor 70 also includes a general purpose processor 76 that assists in loading microcode control store for the microengines 72 and other resources of the processor 70, and performs other general purpose computer type functions such as handling protocols and exceptions.

In network processing applications, where the processor 70 is used as a network processor, the MEs 72 may be used as a high-speed data path, and the general purpose processor 76 may be used as a control plane processor that supports higher layer network processing tasks that cannot be handled by the MEs.

In the illustrative example, the MEs 72 each operate with shared resources including, for example, an external memory system interface 78, an external bus interface 80, an I/O interface 82 and Control and Status Registers (CSRs) 84, as shown. The I/O interface 82 is responsible for controlling and interfacing the processor 70 to various external I/O devices. The external memory system interface 78 is used to access an external memory system. For networking applications, the I/O devices can be any network devices capable of transmitting and/or receiving network traffic data, such as framing/MAC devices, or devices for connecting to a switch fabric. Other devices, such as a host computer and/or bus peripherals (not shown), which may be coupled to an external bus controlled by the external bus interface 80 can also serviced by the processor 70. Each of the functional units of the processor 70 is coupled to an internal bus structure or interconnect 86.

In general, as a network processor, the processor 70 can interface to any type of communication device or interface that receives/sends data. The processor 70 functioning as a network processor could receive units of information from a network device and process those units in a parallel manner. The unit of information could include an entire network packet (e.g., Ethernet packet) or a portion of such a packet, e.g., a cell such as a Common Switch Interface (or “CSIX”) cell or ATM cell, or packet segment.

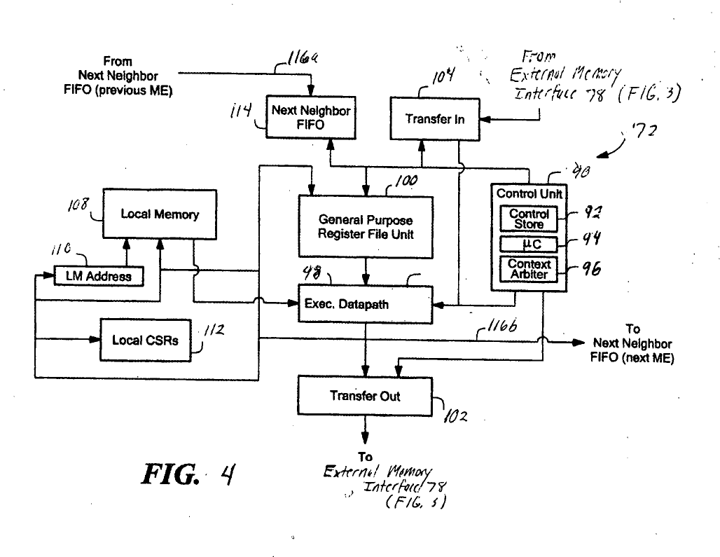

Referring to FIG. 4, an exemplary microengine (ME) 72 is shown. The ME 72 includes a control unit 90 that includes a control store 92, control logic (or microcontroller) 94 and a context arbiter/event logic 96. The control store 92 is used to store microcode. The microcode is loadable by the general purpose processor 76. The functionality of the ME threads 74 is therefore determined by the microcode loaded via the general purpose processor 76 for a particular user's application into the microengine's control store 92.

The microcontroller 94 includes instruction decoder and program counter (PC) units for each of the supported threads. The context arbiter/event logic 96 can receive messages from any of the shared resources, e.g., the external memory, or general purpose processor 76, and so forth. These messages provide information on whether a requested task has been completed. The ME 72 also includes an execution datapath 98 and a general purpose register (GPR) file unit 100 that is coupled to the control unit 90. The GPRs are read and written exclusively under program control. The GPRs, when used as a source in an instruction, supply operands to the datapath 98. When used as a destination in an instruction, they are written with the result of the datapath 98. The instruction specifies the register number of the specific GPRs that are selected for a source or destination. Opcode bits in the instruction provided by the control unit 90 select which datapath element is to perform the operation defined by the instruction.

The ME 72 further includes write transfer (transfer out) register file 102 and a read transfer (transfer in) register file 104. The write transfer registers of the write transfer register file 102 store data to be written to a resource external to the microengine. The read transfer register file 104 is used for storing return data from a resource external to the ME. The transfer register files 102, 104 are connected to the datapath 98, as well as the control unit 90.

Also included in the ME 72 is a local memory 108. The local memory 108, which is addressed by LM address registers 110, supplies operands to the datapath 98, and receives results from the datapath 98 as a destination.

The ME 72 also includes local control and status registers (CSRs) 112, coupled to the transfer registers, for storing local inter-thread and global event signaling information, as well as other control and status information. Other register types of the ME 72 include next neighbor (NN) registers 114, coupled to the control unit 90 and the execution datapath 98, for storing information received from a previous neighbor ME (“upstream ME”) in pipeline processing over a next neighbor input signal 116a, or from the same ME, as controlled by information in the local CSRs 112. A next neighbor output signal 116b to a next neighbor ME (“downstream ME”) in a processing pipeline can be provided under the control of the local CSRs 112. Thus, a thread on any ME can signal a thread on the next ME via the next neighbor signaling.

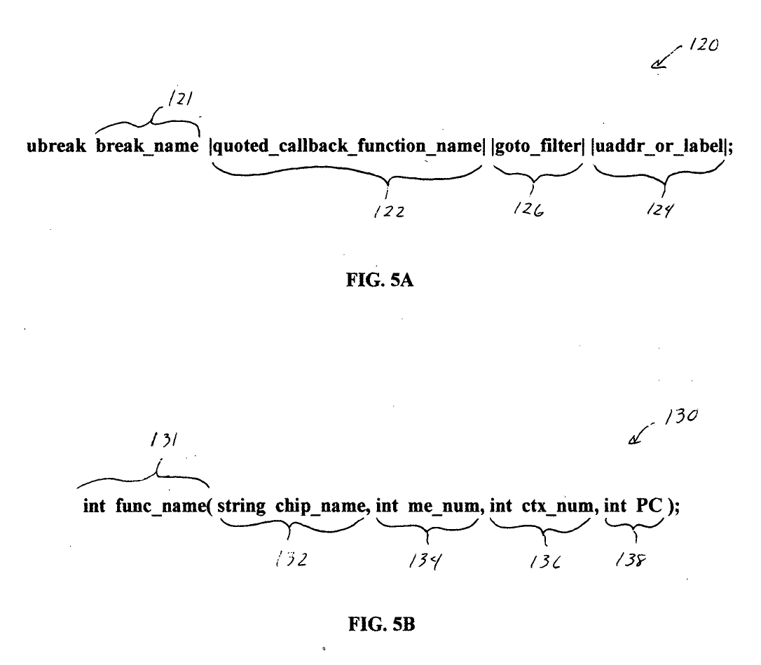

FIGS. 5A-5B, 6 and 7 illustrate various aspects of the breakpointing mechanism when the debugger is implemented to perform simulations of a processor, and more particularly, multi-threaded microengines, like those shown in FIGS. 3-4. In that type of a simulation environment, the simulator 14 executes microcode developed to run on one or more of the microengines 72, and thus simulates the execution of different threads 74 on such microengines. In this context, a breakpoint is a marker associated with a specific microengine and a specific microcode instruction (or source line number). As will be discussed later, a breakpoint (be it conditional or unconditional) may be applied to selected threads. Program execution is suspended when the specified microengine context(s) reaches the designated instruction.

FIG. 5A shows an example of a breakpoint command (shown as ‘ubreak’) 120. In the illustrated example, the breakpoint command 120 has a name (‘break_name’) 121 and includes the following parameters: a breakpoint function name (‘quoted_callback_function_name’) 122; a breakpoint location parameter (‘uaddr_or_label’) 124; and a filter (‘goto_filter’) 126. The effect of this simulator command is to cause the simulator to create a microcode breakpoint state. The breakpoint function name 122 specifies the name of a breakpoint function. Any number of addresses can be related to the breakpoint state by specifying one or more micro-addresses, e.g., in the form of either an address number or label number, as the breakpoint location parameter 124. The filter 126 designates the threads and ME (or MEs) to which the breakpoint should apply. In one embodiment, as discussed earlier, the breakpoint function name 122 may be the name of a pre-existing interpreted function or pre-existing imported function. When the breakpoint is reached, the specified breakpoint function is called with the current breakpoint state information. If the return value from the function is non-zero, the break is activated causing the simulation to halt; otherwise, it is ignored. In the illustrated embodiment, the same breakpoint command may be used for conditional and unconditional breakpoints. When the same command is used, the absence of the breakpoint function name argument in the breakpoint command causes the resulting breakpoint to unconditionally stop simulation. In other words, the inclusion of the breakpoint function name in the breakpoint command serves to “conditionalize” the nature of the breakpoint.

FIG. 5B shows an example of a calling standard 130 for the breakpoint function according to one embodiment, in which the breakpoint function is implemented in interpreted C and the calling standard is an interpreted C calling standard. In the example shown, for a breakpoint function having a function name (‘func_name’) 131, the set or list of arguments that are passed to the breakpoint function when it is called include: a chip name (‘chip_name’) 132 to identify the processor chip containing the breakpoint being tested; an ME number (‘me_num’) 134 to identify the number of the ME (e.g., where the number is in the range of 0 to “n-1” for “n” MEs) containing the breakpoint; a thread/context number (‘ctx_num’) 136 to identify the number of the context (e.g., where context number is in the range of 0 to “N-1” for “N” contexts) that has reached the breakpoint; and the instruction number (or program count, ‘PC’) 138 to specify the instruction number (in the range of 0 to some maximum instruction number) where the breakpoint is set in the ME. The values of these parameters are provided in the breakpoint command, as described earlier. These parameters are used by the breakpoint function in determining whether or not to break.

The typedef designation for the imported function passes similar information. An example typedef designation for an imported function would be: ‘int func_name(char*chip_name, int me_num, int ctx_num, int PC);’.

When the breakpoint command is received, the simulator 14 verifies that the specified breakpoint function, if any, has been previously defined and registered, and conforms to the calling standard. If the breakpoint function has not yet been defined and registered, or does not conform to the calling standard, an error is reported and the breakpoint is not established. When it is time for the simulator 14 to call the breakpoint function, and the breakpoint function is not currently defined for some reason or is defined but does not conform to the calling standard, then a simulation error is reported and program execution pauses as if the breakpoint function had returned a non-zero value. In one embodiment, the simulator 14 automatically removes breakpoints when the corresponding breakpoint function is removed.

Conditional breakpoints can be applied to all contexts or only selected contexts. If the conditional breakpoint is applied to all contexts for a given instruction, the simulator halts program execution when any context in the ME reaches that instruction. If the conditional breakpoint is applied to only one or some of the contexts for a given instruction, then the simulator halts program execution when any context (in the ME) the user has assigned to the breakpoint reaches that instruction.

As described earlier, and referring back to FIGS. 1-2, the CLI 28 is provided as an interface to the simulator command line. Commands entered in the command line of the CLI 28 (“console commands”) are passed to the simulator 14. The command and the simulator responses are logged into a command line output area of the CLI 28. Some console commands are built into the simulator and take the form of traditional commands with space delimited parameters. Other console commands may be statements in an interpreted language, e.g., the interpreted C language, and may be used to declare functions and variables, and to control program flow. Conditional breakpoint commands may be entered at the command line of the CLI. Definitions for the breakpoint functions specified by such commands may have been entered at the command line as well, or in some other manner (e.g., GUI menu driven script generation). Alternatively, the user may generate conditional breakpoint commands via the GUI 26. When a user uses the GUI controls for conditional breakpointing, the GUI 26 sends the appropriate command to the simulator as if the user entered the command on the command line of the CLI 28. The breakpoint command generation (block 48, FIG. 2) can be performed by using CLI commands or GUI controls that produce the equivalent commands.

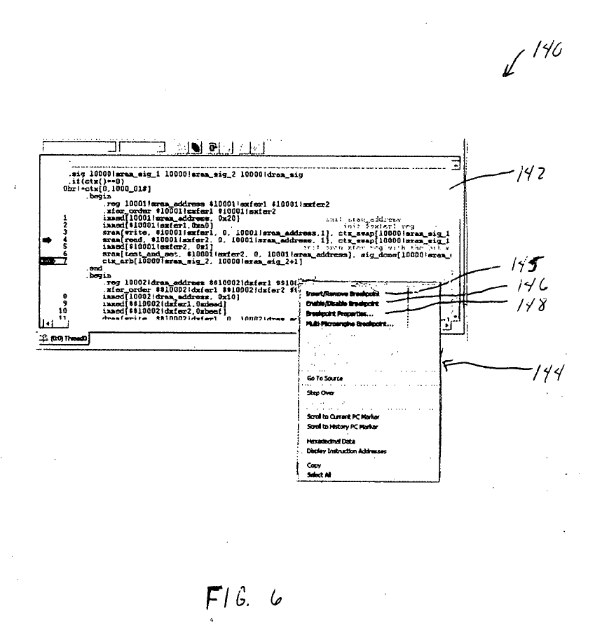

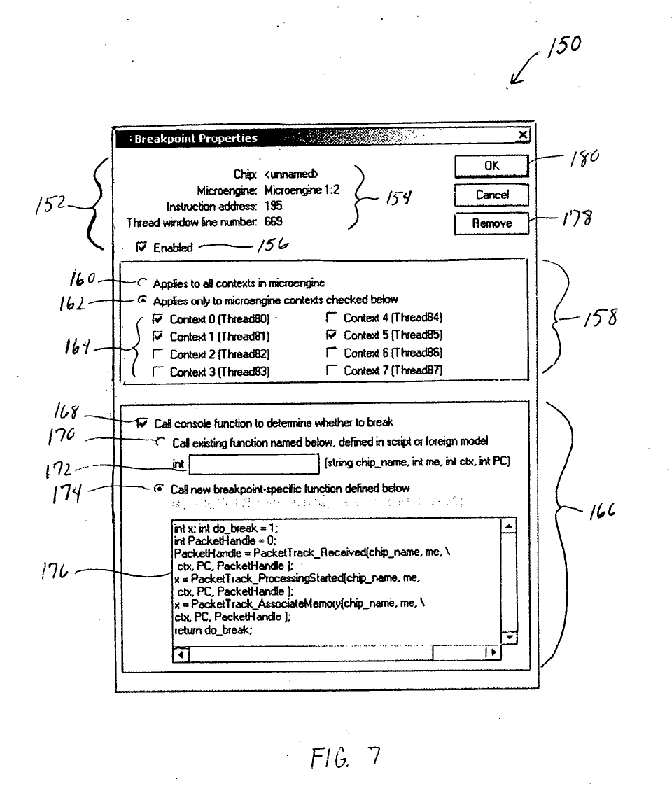

The use of the GUI to set a conditional breakpoint will now be described with reference to FIGS. 6-7. Referring to FIG. 6, an exemplary screen capture 140 of a Thread Window or Code List View 142 (presented by the GUI 26 from FIG. 1) is shown. The Thread Window 142 displays lines of user program code as the code executes during a simulation session. To insert a breakpoint in an ME, the user can open the Thread Window 142 for one of the threads in the ME and place the insertion cursor on the line where the user wishes to insert the breakpoint. The user can right-click on an instruction (line of code) and be provided with a pop-up shortcut menu 144 that includes as menu items the following: ‘Insert/Remove Breakpoint’ 145; ‘Enable/Disable Breakpoint’ 146; and ‘Breakpoint Properties’ 148. The user can select the ‘Insert/Remove Breakpoint’ to insert the breakpoint. Once the breakpoint is set, the user can convert the breakpoint from an unconditional breakpoint to a conditional breakpoint by selecting ‘Breakpoint Properties’ 148.

In response to the user selecting ‘Breakpoint Properties’ 148, the GUI presents the user with a breakpoint properties editor. In the illustrated embodiment, and referring now to FIG. 7, an exemplary breakpoint properties editor is shown as Breakpoint Properties dialog box 150. In the embodiment shown, the Breakpoint Properties dialog box 150 is divided into three areas. A first section 152 provides information about the chip, the ME thread and instruction to which the breakpoint applies (information 154). On the first line of information, ‘Chip’ identifies the name of the processor chip containing the breakpoint being tested. On the second line of the information, ‘Microengine’ identifies the number of the ME where the breakpoint is assigned. On the third line, the ‘Instruction address’ provides the PC address. On the fourth line, ‘Thread window line number’ is the thread window line number corresponding to the instruction having the address shown in the third line. The first section 152 further provides an ‘enabled’ box 156 to allow the user to enable or disable the breakpoint. The enabled box 156, when selected, indicates that the associated breakpoint is active. When the enabled box is not checked, the breakpoint is disabled.

Still referring to FIG. 7, a second section 158 is used to select which contexts are to be assigned to the breakpoint. When a first option 160, shown as an ‘Applies to all contexts in microengine’ option, is selected, the breakpoint is associated with all contexts in the ME. A second option 162, shown as an ‘Applies only to microengine contexts checked below’ option, allows the user to associate the breakpoint with fewer than all of the contexts in the ME. Individual context check boxes 164 are provided for each available context. In the example shown, there are check boxes 164 for eight contexts. The user assigns the desired contexts by clicking on the corresponding check boxes. A third section 166 is used to set conditional breakpoints. It includes a check box 168, shown as a ‘Call console function to determine whether to break’ check box, which when checked enables conditional breakpoints. Under the check box enabling conditional breakpoints are two options. A first option is a checkbox 170, shown as a ‘Call existing function named below defined in script or foreign model’ option, which when selected sets a conditional breakpoint with a pre-existing breakpoint function that is defined in a script file or is contained in a foreign model. A field 172 is provided to accept the function name. A second option is a check box 174, shown as a ‘Call new breakpoint specific function defined below’ checkbox, which when selected sets a conditional breakpoint with a breakpoint function that is entered in a text box 176 by the user.

Thus, according to one GUI-based technique, the user types the body text of the breakpoint function into the text box 176 provided by the Breakpoint Properties dialog. When the Breakpoint Properties dialog is closed (by clicking an ‘OK’ button 180) to accept the changes, the GUI 26 provides the breakpoint function definition text directly to the simulator 14 in order to define and register the breakpoint function. If the breakpoint function needs to change, the user can open the Breakpoint Properties dialog box and modify the body text. When the Breakpoint Properties dialog box is closed, the GUI 26 redefines the previous breakpoint function definition in the simulator 14. When the breakpoint function is either created or edited using the Breakpoint Properties dialog, the change takes effect when the dialog is applied (e.g., when the user clicks the OK button 180). If the breakpoint function previously existed, it is automatically removed and then redefined. The change therefore takes effect immediately, without the user exiting and restarting the simulation.

According to another GUI-based technique, the user types the name of a breakpoint function name into field 172 (provided by the Breakpoint Properties dialog box) to use a breakpoint function contained in a script or foreign model. In the case of a script, the user is responsible for defining the breakpoint function manually in a script file or by typing the function text directly on the command line of the command line interface (CLI). If the breakpoint function body needs to change, the user is responsible for removing the old definition using a simulator ‘remove’ command before entering in the new definition. The user simply edits the script file whenever the breakpoint function definition needs to change. In the case of a foreign model, the user must have previously defined the breakpoint function in a foreign model specified through the user interface and loaded at simulation startup.

Once in the dialog box 150, the user can select or clear ‘Enabled’ box 156 to enable or disable the breakpoint, select contexts and select (or change) the functions the user wishes to associate with the breakpoint. Other properties may be specified as well. The user can also remove a breakpoint from within the dialog box by clicking on a remove button 178. With both of above GUI-based techniques, the GUI 26 will issue the breakpoint command to the simulator 14 to establish the conditional breakpoint (if not already established).

If the dialog box is not used to set the breakpoint, but instead the CLI is used to set the breakpoint, the user can still place the breakpoint function definition in a script file that is executed automatically at simulation startup or use a breakpoint function defined in a foreign model. As discussed earlier, the user can type the breakpoint command (for example, according to the format shown in FIG. 5A) into the CLI text edit control for entering commands. The CLI 28 sends the command to the simulator 14 to establish the breakpoint. If the breakpoint command specifies a breakpoint function, a conditional breakpoint is established.

When a breakpoint is set on a microcode instruction, a breakpoint icon may be displayed in the left-hand margin of the corresponding line in the Thread Window 142. The breakpoint icon's appearance may be designed to convey the properties of the breakpoint. For example, the Thread Window 142 may mark a conditional breakpoint that uses a breakpoint function with a different icon or set of icons than those used to indicate unconditional breakpoints.

Although not illustrated, it will be appreciated that any of the breakpoint “options” (e.g., Enable/Disable Breakpoint, Insert/Remove Breakpoint and Breakpoint Properties) may be available through appropriate GUI Debug toolbar and menu selections as well. On the Debug menu, for example, the user may click ‘Breakpoint’ followed by ‘Insert/Remove’ (or the equivalent function key or button on the Debug toolbar). The Breakpoint Properties Dialog Box can also be reached from the Debug menu (by clicking ‘Breakpoint’ followed by ‘Properties’) as well.

The conditional breakpointing mechanism of the described embodiment allows the breakpoint to be established in two parts, breakpoint function definition and breakpoint command issuance, thus providing for a breakpoint command that is de-coupled from the breakpoint function definition. Because of the de-coupled nature of the breakpoint command and function, the user has the flexibility to move a breakpoint function to different PC, thread, ME or chip just by issuing a ‘remove breakpoint’ command (e.g., by clicking the remove button 178 in the Breakpoint Properties dialog box 150, or using the menu option ‘Insert/Remove Breakpoint’ 145) and then issuing a new breakpoint command (as described above) that provides the new values for the breakpoint function arguments.

Breakpoint functions may be defined to do any number of different tasks, for example, to test and set simulation states, create and manipulate variables, call other functions, and execute built-in console commands. In a simple example, a breakpoint function could be defined to execute a console command, such as print statement (to print to the CLI), and return a zero so that a break does not occur. This would be useful to report some event to the user, for example, that a particular processing stage has been entered by an ME. In another example, a breakpoint function could be defined to perform some type of diagnostic test, such as inspecting a variable for an expected value, to detect an error condition and return a ‘1’ only if the error condition is detected. The breakpoint function could also log the error. In a more complex networking application example, the breakpoint function could be used to diagnose a rate problem. A first breakpoint could be set with a function to record a cycle time without breaking and a second breakpoint could be set with a function to calculate a time difference (using the earlier recorded time value and a current time value) to determine if the rate at which processing is occurring exceeds a desired or required rate budget, breaking only if the condition is satisfied. Example interpreted C code to implement a breakpoint function for yet another network application example is shown below:

in da = Dbg_GetVariable(“10078!da“, chip_name, me, ctx, PC, 0);
if ((da > 0)&&(da < 0xffffff)){
return1;
}else return 0;

In the above example, the breakpoint function accesses an IP destination address variable (“da”), tests whether its value is within a specified range of values, and breaks only if the condition is satisfied.

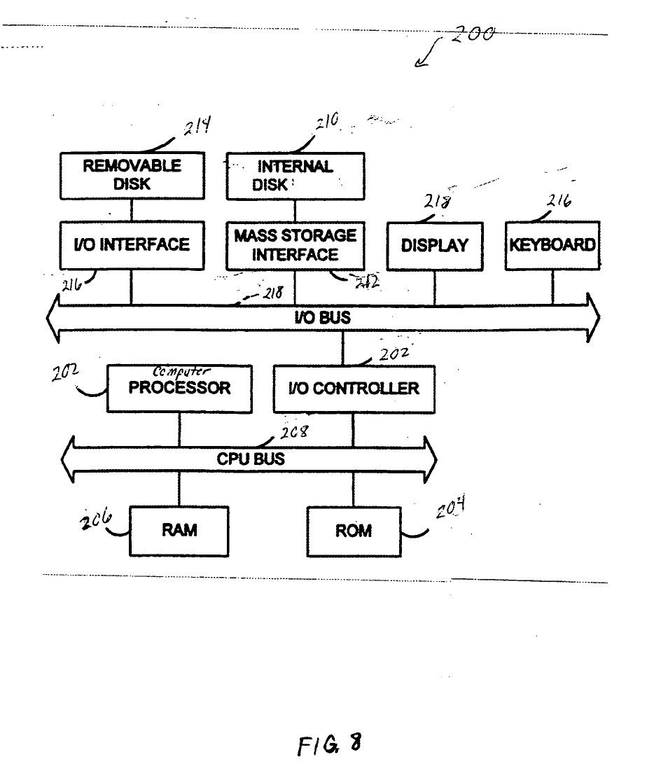

Referring to FIG. 8, an exemplary computer system 200 suitable for use as a development/debugger system and, therefore, for supporting the debugger 10 of FIG. 1 (including the conditional breakpointing process and any other processes used or invoked by it), is shown. The debugger 10 may be implemented in a computer program product tangibly embodied in a machine-readable storage device for execution by a computer processor 202; and methods of the tool may be performed by the computer processor 202 executing a program to perform functions of the debugger tool by operating on input data and generating output.

Suitable processors include, by way of example, both general and special purpose microprocessors. Generally, the processor 202 will receive instructions and data from a read-only memory (ROM) 204 and/or a random access memory (RAM) 206 through a CPU bus 208. A computer can generally also receive programs and data from a storage medium such as an internal disk 210 operating through a mass storage interface 212 or a removable disk 214 operating through an I/O interface 216. The flow of data over an I/O bus 218 to and from devices 210, 214, (as well as input device 216, and output device 218) and the processor 202 and memory 206, 204 is controlled by an I/O controller 220. User input is obtained through the input device 216, which can be a keyboard (as shown), mouse, stylus, microphone, trackball, touch-sensitive screen, or other input device. These elements will be found in a conventional desktop computer as well as other computers suitable for executing computer programs implementing the methods described here, which may be used in conjunction with output device 218, which can be any display device (as shown), or other raster output device capable of producing color or gray scale pixels on paper, film, display screen, or other output medium.

Storage devices suitable for tangibly embodying computer program instructions include all forms of non-volatile memory, including by way of example semiconductor memory devices, such as EPROM, EEPROM, and flash memory devices; magnetic disks s u c h as internal hard disks 210 and removable disks 214; magneto-optical disks; and CD-ROM disks. Any of the foregoing may be supplemented by, or incorporated in, specially-designed ASICs (application-specific integrated circuits).

Typically, the debugger 10 and other related processes reside on the internal disk 210. These processes are executed by the processor 202 in response to a user request to the computer system's operating system after being loaded into memory. Any files or records produced by these processes may be retrieved from a mass storage device such as the internal disk 210 or other local memory, such as RAM 206 or ROM 204.

The system 200 illustrates a system configuration in which the debugger 10 is installed on a single stand-alone system. In another configuration, the debugger 10 may be installed on a networked computer system for local user access. In yet another configuration, the software or portions of the software provided or used by the debugger 10 may be installed on a file server to which the system 200 is connected by a network, and the user of the system accesses the debugger software over the network. The foreign model (shown as a part of the debugger 10) may run on the same system as the simulator, or may run on a different system. For example, the simulator 14 may communicate over a network with a foreign model running on a remote system. Also, the debugger may be configured to operate in a hardware debugging mode in additional to simulation mode, and thus debugger/system 200 could be coupled to and communicating with (over a network or serial port) a subsystem containing the actual target processor.

Other embodiments are within the scope of the following claims.

1. A method comprising:
associating a breakpoint with a breakpoint function that will execute when the breakpoint is reached during a debugging session.

2. The method of claim 1 wherein associating comprises:
enabling a user to provide a function as the breakpoint function; and
enabling the user to generate a conditional breakpoint command that specifies parameters for the breakpoint function.

3. The method of claim 2 wherein associating further comprises:
causing the breakpoint to be set on an instruction of a program to be debugged during the debugging session.

4. The method of claim 3 wherein the program comprises microcode to be executed by a network processor and the debugging session is performed by a simulator configured to simulate the network processor.

5. The method of claim 4 wherein the network processor comprises multi-threaded processing elements and the microcode is intended to run on one or more of the multi-threaded processing elements.

6. The method of claim 5, further comprising:
executing the microcode during the debugging session;
determining, during the microcode execution, if the breakpoint has been reached; and
if the breakpoint has been reached, calling the breakpoint function to execute.

7. The method of claim 6, further comprising:
receiving a value returned by the breakpoint function; and
determining from the value if a break in the microcode execution should occur.

8. The method of claim 6 wherein the parameters of the conditional breakpoint command specify a name of the breakpoint function, a location where the breakpoint is to be set in the microcode, and any threads to which the breakpoint applies.

9. The method of claim 1 wherein the breakpoint function is defined in a script.

10. The method of claim 1 wherein the breakpoint function is provided in a dynamically linked library (DLL).

11. An article comprising:
a storage medium having stored thereon instructions that when executed by a machine result in the following:
associating a breakpoint with a breakpoint function that will execute when the breakpoint is reached during a debugging session.

12. The article of claim 11 wherein associating comprises:
enabling a user to provide a function as the breakpoint function; and
enabling the user to generate a conditional breakpoint command that specifies parameters for the breakpoint function.

13. The article of claim 12, wherein associating further comprises:
causing the conditional breakpoint to be set on an instruction of a program to be debugged during the debugging session.

14. The article of claim 13 wherein the program comprises microcode to be executed by a network processor and the debugging session is performed by a simulator configured to simulate the network processor.

15. The article of claim 14 wherein the network processor comprises multiple multi-threaded processing elements and the microcode is intended to run on one or more of the multi-threaded processing elements.

16. The article of claim 15, wherein the instructions further comprise instructions that when executed by a machine result in the following:
executing the microcode during the debugging session;
determining, during the microcode execution, if the breakpoint has been reached; and
if the breakpoint has been reached, calling the breakpoint function to execute.

17. The article of claim 16 wherein the instructions further comprise instructions that when executed by a machine result in the following:
receiving a value returned by the breakpoint function; and
determining from the value if a break in the microcode execution should occur.

18. The article of claim 16 wherein the parameters of the conditional breakpoint command specify a name of the breakpoint function, a location where the breakpoint is to be set in the microcode, and any threads to which the breakpoint applies.

19. The article of claim 18 wherein calling the breakpoint function to execute comprises passing the parameters to the breakpoint function.

20. The article of claim 11 wherein the breakpoint function is defined in a script that is written in an interpreted language.

21. The article of claim 11 wherein the breakpoint function is provided in a dynamically linked library.

22. A user interface comprising:
a first user interface that provides a user with graphical user interface (GUI) controls; and
the GUI controls enable the user to associate a breakpoint with a microcode instruction in a program and a breakpoint function that will execute when the microcode instruction is reached during execution of the program by a simulator.

23. The user interface of claim 22 wherein the GUI controls provide the user with a window showing a view of microcode instructions that executed by the simulator during simulation, the view being usable to provide a breakpoint properties option in a menu presented to a user for the microcode instruction upon selection by the user, and the breakpoint properties option being usable to specify a function to be used as the breakpoint function.

24. The user interface of claim 23 wherein the program is developed for use by a processor that includes multi-threaded processing elements and the view corresponds to a selected one of the multi-threaded processing elements.

25. The user interface of claim 23 wherein the breakpoint properties option, when selected, opens a breakpoint properties dialog box that identifies the microcode instruction and the selected multi-threaded processing element, and allows the user to select threads of the multi-threaded processing element to which the breakpoint is to apply.

26. The user interface of claim 25 wherein the breakpoint properties dialog box allows a user to type in a text box text that defines the breakpoint function, as a first option, and to specify a pre-existing breakpoint function as the breakpoint function, as a second option.

27. The user interface of claim 26 wherein the pre-existing breakpoint function is defined in either a script or a dynamic linked library (DLL).

28. The user interface of claim 23, further comprising a second user interface to enable the user to associate the breakpoint with the breakpoint function using a command line of the simulator instead of the GUI controls.

29. A system comprising:
a CPU;
a memory coupled to the CPU;
debugger software, stored in the memory, to be executed by the CPU during a debugging session; and
wherein the debugger software is usable to associate a breakpoint with a location in a program and a breakpoint function that will execute when the location is reached during the debugging session.

30. The system of claim 29 wherein the debugger software includes software usable to provide a function as the breakpoint function and software usable to generate a conditional breakpoint command that specifies parameters for the breakpoint function.
